(19) United States
(12) Patent Application Publication
(10) Pub. No.: US 2010/0161440 A1
(43) Pub. Date: Jun. 24, 2010

(54) A METHOD FOR THE UPKEEP OF A RESIDENCE

(76) Inventor: Travis Parton, Des Moines, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/341,340

(22) Filed: Dec. 22, 2008

(51) Int. Cl. G06Q 30/00; G06Q 50/00; G06Q 20/00

(52) U.S. Cl. 705/26; 705/400; 705/40; 705/34

(57) ABSTRACT

A method for the upkeep of a residence that includes providing a computer that has a service menu. The service menu has a plurality of services for maintaining, improving and preserving a residence and a payment menu comprising payment options to a homeowner. A homeowner can then use the service menu to select a service to be provided at a residence. The program then calculates a selected service price for the service to be performed and a payment option for the service to be performed is selected. At this point the service is performed for the homeowner.

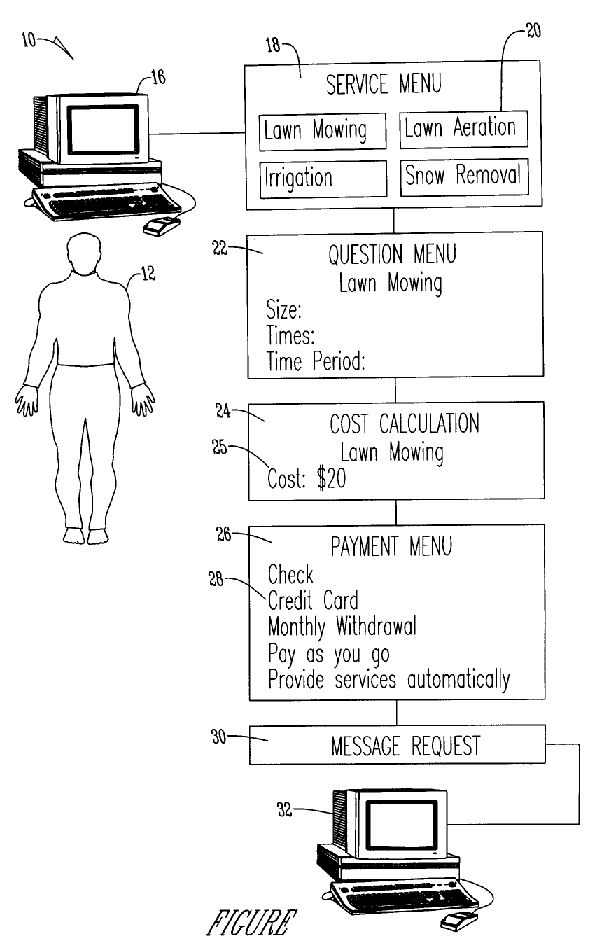

### BACKGROUND OF THE INVENTION

This invention is directed to a method of upkeep for a residence. More specifically, the invention is directed towards a method of upkeep for a residence that provides a homeowner with a variety of services and payment options.

While there are many advantages that come with owning a home, homeownership is necessarily accompanied by the fact that a residence is something that requires constant maintenance and care. As a result, townhomes and planned developments have become attractive options for individuals who simply do not have the time or desire to devote to maintaining a residence themselves, due to the fact that such developments feature membership associations that provide routine maintenance services such as lawn care and snow removal for their units. However, many individuals who desire such benefits have found that townhomes and planned developments are not a preferable choice.

Townhomes are often designed as a series of small, similar, individual units built into a highly concentrated area often directly connected to one or more other units; and as such, those seeking the space and separation from neighbors that a house provides do not typically consider a townhome an acceptable substitute. Furthermore, whether considering a townhome or a home that is part of a planned development, the convenience of the membership association's maintenance services is often outweighed by strict guidelines imposed by the association which often drastically limit the choices the homeowner has in making changes to the residence.

It is therefore an objective to provide a method of upkeep for a residence that is available to all homeowners owning homes in any location.

Another objective is to provide a method of upkeep for a residence that does not require the homeowner to join a membership association.

Yet another objective is to provide a method of upkeep for a residence that provides homeowners with greater flexibility in selecting, planning, and paying for services to maintain the upkeep of their residence.

These and other objectives will be apparent to those skilled in the art based on the following written description.

### BRIEF SUMMARY OF THE INVENTION

A method for the upkeep of a residence includes providing a service menu having a plurality of services for maintaining, improving, and preserving a residence and a payment menu with payment options to a homeowner having a residence with a home and a yard. The homeowner is allowed to select from the service menu services to be performed at the homeowner's residence. A selected service price is provided for each selected service. A payment option is selected where selection of the payment option controls the frequency in which the services selected by the homeowner are provided in addition to the manner that the homeowner pays for the service.

### BRIEF DESCRIPTION OF THE DRAWINGS

The figure is a schematic diagram of a system for providing a means for upkeep of a residence.

### DETAILED DESCRIPTION OF THE PREFERRED EMBODIMENT

The figure shows a system 10 that a homeowner 12 can use in order to obtain upkeep for their residence 14. The system 10 includes a service menu 18 that provides a plurality of services for maintaining, improving and preserving a residence. The plurality of services are represented by numeral 20. In order for the homeowner 12 to provide upkeep for their residence 14 the homeowner 12 selects from the service menu 18 one or more services 20 to be performed at the residence 14 of the homeowner 12. At this point in time the homeowner 12 may be asked specific questions from a question menu 22 about the service selected and the residence 14. A cost 24 is then calculated regarding the selected service and residence 14 of the homeowner 12 in order to provide a service price 25. The homeowner 12 is then prompted to a payment menu 26 that allows the homeowner 12 to select a payment option 28 for the service to be performed. Once a payment option 28 has been made a message 30 is sent to a service provider 32 who then performs the selected service at the residence 14 of the homeowner 12.

In one embodiment, a computer 16 can be used to access an online version of the system 10 provided on the internet. On the internet a webpage is found that presents the service menu 18, the question menu 22, and the payment menu 26. Just as above, the homeowner 12 can select services 20 to be provided at the residence 14 from the service menu 18, is asked specific questions from a question menu 22 about the service selected and the residence 14, and is prompted to a payment menu 26 that allows the homeowner 12 to select a payment option 28 for the service to be performed via an online connection between the homeowner's computer 16 and the system 10. Once the service provider 32 receives the message 30 that the payment option 30 has been made, the service provider 32 performs the selected service at the residence 14 of the homeowner 12.

The method provides a means of upkeep for a residence 14 that provides a homeowner 12 with a variety of services 20 and payment options 28 to make homeownership more convenient and less burdensome. The service menu 18 includes a list of the services available for the homeowner to select, including, but not limited to, lawn mowing, including trimming/weed eating around trees, fences, etc., bagging, and blowing excess lawn clippings from the lawn, edging lawn borders adjacent to driveways, sidewalks and paths, lawn aerating, mulch services, bush trimming, leaf removal, cleaning and removing debris from gutters, snow removal & de-icing, general contracting, day-maid service, window cleaning, computer tech assistance, exterior and interior car cleaning/detailing, pet services (grooming & walking) and general household tasks/concierge service which include any miscellaneous tasks that is needed to be done for or by the residents of the household. The services differ in price depending upon the type of service 20 that is to be performed.

Additionally, each service 20 is associated with a price range such that the price of the service 20 is determined by characteristics of the residence 14 of the homeowner 12. This includes, for example only, the size of the homeowner's yard, where prices charged to homeowners with smaller yards represent the lower end of the range, and homeowners with larger yards are charged prices out of the higher end of the range.

In order to calculate the selected service price of the service selected by the homeowner 12 at step 24, a price range is determined based upon the price range associated with each individual service 20 and then a specific price out of the range is provided based upon the size of the homeowner's yard. For illustration purposes only, homeowners 12 can be grouped into three categories, those having small yards which are less than 10,000 square feet, representing the lower third of the pricing range, those having medium-sized yards which are between 10,001-30,000 square feet, representing the middle third of the pricing range, and homeowners 12 with large yards between 30,001 and 60,000 feet, which represent the upper third of the pricing range. In the case of homeowners having yards over 60,000 feet, the pricing range will not apply and special pricing will be considered.

The homeowner 12 is also provided with a payment menu 26 which offers various payment options 28. The various payment options 28 available to the homeowner 12 in the payment menu 26 provide the homeowner with flexibility not only in the manner in which the homeowner pays for the services but also the manner in which the services are provided. One payment option enables the homeowner 12 to select specific services to be provided at specific times that the homeowner wants the services to be performed, e.g., a “pay-as-you-go” basis. The homeowner 12 is then charged the selected service price 25 (which is based upon the specific service 20 chosen and the characteristics of the residence 14 of the homeowner 12, as described) for each service that was performed either as the services are completed, or, after a determined time period (e.g., a month, 6 months, a year), the selected service prices 25 for each service selected and performed during that period are totaled and charged to the homeowner 12.

Another payment option 28 enables the homeowner to select services to be provided automatically throughout a time period. The homeowner 12 first selects which services 20 the homeowner 12 desires to be performed at their residence 14, and then selects the period of time over which the homeowner 12 wants the services to be performed. After the homeowner 12 selects which services 20 are desired over a pre-determined time period, the overall price for the time period is calculated for all of the services 20 chosen to be performed during the time period. The overall price for the time period is calculated by first determining the selected service price 25. Next, considering the pre-determined time period desired, an estimate is figured of the number of times or frequency that the particular service would have to be provided in order to maintain the upkeep of the homeowner's residence 14. The estimate of the number of times the service 20 would be provided during the time period is multiplied by the selected service price 25 to arrive at the individual service price. Each individual service price for each individual service 20 selected is then added together to arrive at the overall price for the time period.

The overall price for the time period is broken down into installments, or a series of set incremental installment prices, to be paid at discrete, uniform intervals over the course of the pre-determined time period, while the services the homeowner selected are provided automatically on a routine basis to maintain upkeep of the homeowner's residence. In addition to being provided with the automatic services selected in advance, the owner has the option to order additional services on an as-needed basis, with the individual service price(s) for each additional service added to the set incremental installment price in which the additional services were selected.

Therefore, it can be seen that this invention, by presenting a wide variety of helpful services along with payment options which provide flexibility both in the manner in which the homeowner pays for the services and in the manner in which the services are provided, the method of upkeep for a residence fulfills its objective in making home ownership more convenient and less burdensome. It will be appreciated by those skilled in the art that other various modifications could be made to the invention without the parting from the spirit in scope of this invention. All such modifications and changes fall within the scope of the claims and are intended to be covered thereby.

1. A method for the upkeep of a residence comprising the steps of:
providing a service menu comprising a plurality of services for maintaining, improving, and preserving a residence and a payment menu comprising payment options to a homeowner;
selecting from the service menu a service to be performed at the residence of the homeowner;
calculating a selected service price for the service to be performed;
selecting a payment option for the service to be performed; and
performing the selected service at the residence of the homeowner.

2. The method of claim 1 further comprising the step of: inputting information regarding the selected services; and calculating the selected service price based on the inputted information.

3. The method of claim 2 wherein the inputted information includes yard size.

4. The method of claim 1 wherein the payment option comprises allowing the homeowner to choose one or more services from the service menu to be performed throughout an overall time period, calculating an overall price for all services chosen to be performed during the overall time period, charging the homeowner a set incremental installment price of the overall price at uniform times during the overall time period, and performing the services on a routine basis to maintain upkeep of the homeowner's residence.

5. The method of claim 1 wherein the calculated selected service price is calculated by multiplying the selected service price by a pre-determined variable to determine an individual service price and summing each individual service price.

6. The method of claim 5 wherein the pre- determined variable is determined by the number of times a selected service is expected to be necessary during the overall time period in order to maintain upkeep of the residence of the homeowner.

7. The method of claim 1 wherein the payment option comprises allowing the homeowner to choose one or more services to be performed a specific number of times during a specified period, performing the services as chosen during the specified period, and at the end of the specified period, charging the homeowner the selected service price each time the selected service was provided.

8. The method of claim 1 wherein the plurality of services for maintaining, improving, and preserving a residence comprises lawn mowing, lawn aerating, irrigation, providing mulch, bush trimming, leaf removal, gutter cleaning and debris removal, snow removal, general contracting, daytime housecleaning, and window cleaning.

9. The method of claim 1 wherein the service menu and the payment menu are provided on a computer.
